(19) United States
(12) Patent Application Publication
(10) Pub. No.: US 2003/0129483 A1
(43) Pub. Date: Jul. 10, 2003

(54) Battery and method of packaging

(76) Inventor: Oliver J. Gross, Rand Rock, TX (US)

Correspondence Address: VALENCE TECHNOLOGY, INC., 301 CONESTOGA WAY, HENDERSON, NV, 89015, US

(21) Appl. No.: 10/042,807

(22) Filed: Jan. 9, 2002

(51) Int. Cl. H01M 2/08; H01M 2/02

(52) U.S. Cl. 429/127; 429/185; 29/623.2

(57) ABSTRACT

A method of packaging a lithium ion battery using compound folding to seal the battery and thereby provide a more compact design that also reduces vibration caused by mechanical shocks is provided. A compound fold is made along the edge of the battery packaging to seal a cell therein. The compound fold extends generally from a centerline of the cell between a top and bottom surface of the cell. Different shapes of compound folds may be provided.

### FIELD OF THE INVENTION

The present invention relates generally to electrochemical cells and batteries, and more particularly to a method of packaging such cells using a compound fold to simplify the packaging process.

### BACKGROUND OF THE INVENTION

The increased use of mobile electronic devices, and in particular to such devices having smaller casings (e.g., Personal Digital Assistants (PDAs)) and cellular telephones), to perform everyday tasks, has resulted in a need to provide smaller and more powerful batteries for use in these devices. Because of the limited space within the devices, design tolerances are very tight, thereby requiring that the component parts, including the batteries for providing power, are manufactured within very narrow specification limits. It is extremely important that these batteries are packaged (i.e., encased) to minimize unused space (i.e., make battery more compact) while providing flexibility to accommodate different types of applications and battery manufacturing processes.

In particular, the manufacture and use of lithium ion batteries has allowed the use of different configurations and sizes of batteries for powering devices (e.g., portable personal communication devices) in many different applications not previously possible. In many of these applications (e.g., cellular telephones) it is important to provide a space saving battery that allows flexibility in design. For example, some applications will require a battery having a narrow footprint with tight design tolerances. It is often critical to manufacture these batteries such that the overall packaged battery size is as small as possible for the particular application, while providing flexibility in packaging operation. Further, it is important to protect these batteries, such that damage from external forces (e.g., vibrations) are minimized.

It is known to use sachet-packaging to seal a lithium ion cell. Typically, the edges of the packaging are folded (e.g., single fold) to seal a cell therein. The folding is provided from the top of the packaging, which becomes more difficult as battery cell size decreases. In particular, as battery cell size decreases, and specifically as thickness decreases, compound folding (i.e., more than one fold) of the battery packaging to seal the cell and make it as compact as possible is typically required. However, a minimum seal width, typically of about 2.0 mm, must be maintained to provide acceptable package reliability. Known methods for packaging are not only complex, but as battery size decreases, it is more difficult to make a compact cell of high relative energy density and ensure reliable package hermeticity.

### SUMMARY OF THE INVENTION

It will become apparent from the disadvantages of the prior art that a need exists for a method of packaging a battery (e.g., lithium ion battery) using a compound fold that simplifies the packaging process when sealing a cell within the packaging (e.g., sachet-packaged cell). It is also desirable to allow for different folding configurations based upon the requirements of a specific application and/or the operating characteristics of the machinery used to package the cells, particularly as battery cell size decreases.

The present invention provides a method for packaging (i.e., encasing or enclosing) batteries, and in particular, lithium ion batteries, that simplifies the packaging process, while allowing flexibility in packaging operation. Generally, a compound folded packaging for sealing cells (e.g., lithium ion cells) therein is provided. The compound fold is provided around the sides of and extends generally from a centerline of the cell. Specifically, a method of packaging a battery of the present invention provides for sealing a cell within a packaging material to form a substantially flat edge extending generally from a centerline of the cell and folding the edge seal along multiple substantially parallel lines from about the centerline of the cell. The compound fold may be configured in different shapes and configurations as needed or required, including, for example, a J-shape or fold, a Z-shape or fold, a G-shape or fold, or a coiled shape or fold, among others.

The present invention also provides a battery comprising a cell having a positive electrode, a negative electrode, and a separator between the positive and negative electrodes, a positive electrode terminal connected to the positive electrode, a negative electrode terminal connected to the negative electrode, with the terminals together adapted for providing power to an external load, and a casing having a top and bottom surface for enclosing therein the cell. The top and bottom surfaces are compound folded together with the fold extending generally from a point approximately intermediate to the top and bottom surfaces. The casing may comprise any suitable material, including, for example, a flexible foil material. Further, the fold may be configured in different shapes, including a “J”, “Z” or “G” fold, among others.

Thus, the present invention provides a method of packaging a battery using a compound fold that can reduce the area needed to make the fold (i.e., sealed portion protrudes or extends less distance from the packaging), while allowing flexibility in design (e.g., different shape folds using different packaging processes).

Further areas of applicability of the present invention will become apparent from the detailed description of the preferred embodiments, claims and accompanying drawings provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1(a) is a top perspective view of a typical lithium ion battery with the peripheral seal in an unfolded configuration;

FIG. 1(b) is a top plan view of the lithium ion battery of FIG. 1(a);

FIG. 2 is a cross-sectional view of the lithium ion battery of FIG. 1(a) taken along the line 2-2;

FIG. 3 is a cross-sectional elevation view of a typical prior art fold for use in sealing a packaged lithium ion battery;

FIG. 4(a) is a top plan view of a typical prior art lithium ion battery having a single fold seal;

FIG. 4(b) is a side elevation view of the prior art lithium ion battery of FIG. 4(a); and

FIGS. 5(a)-5(c) are cross-sectional elevation views of compound folds of the present invention for use in packaging a lithium ion battery.

### DETAILED DESCRIPTION OF THE PREFERRED EMBODIMENTS

The following description of the preferred embodiments is merely exemplary in nature and is in no way intended to limit the invention, its application, or uses. Thus, variations and modifications are contemplated, including, for example, different shapes of compound folds as described in more detail herein. As used herein, compound fold means more than one fold, wherein at least one fold is in one direction, and at least another fold is in the generally opposite direction. Further, it should be noted that when reference is made to centerline or intermediate, this refers to a point approximately between a top and bottom surface of a battery.

Electrochemical batteries, and specifically, lithium batteries, are used to power many smaller mobile electronic devices, such as, for example, PDAs, cellular telephones, pagers and laptop computers. These batteries are used in part because of their light weight and compact size, as well as their high energy level. Shown in exemplary form in FIGS. 1 (a) and 1(b) is a lithium ion battery 10 for use in a smaller mobile electronic device, such as, for example, a PDA or cellular telephone.

A lithium ion battery 10 for powering a smaller mobile electronic device may be manufactured in various shapes and sizes, including, for example, about 35 mm in width by 45 mm in length, with a nominal thickness (i.e., height) of about 2 mm, and may provide a nominal capacity of 250 mAh at more than 3.6 volts. Further, the nominal weight of such a lithium ion battery 10 may be about 6 grams. An example of a lithium ion battery 10 having these specifications and performance ratings is the Model C43 Series Lithium Ion Polymer Battery manufactured and sold by Valence Technology, Inc. It should be noted that other battery configurations are possible, including, for example, the narrow footprint Model 74 Series Polymer Batteries manufactured and sold by Valence Technology, Inc. The present invention may be implemented, for example, with these or any battery having a foldable flat edge seal.

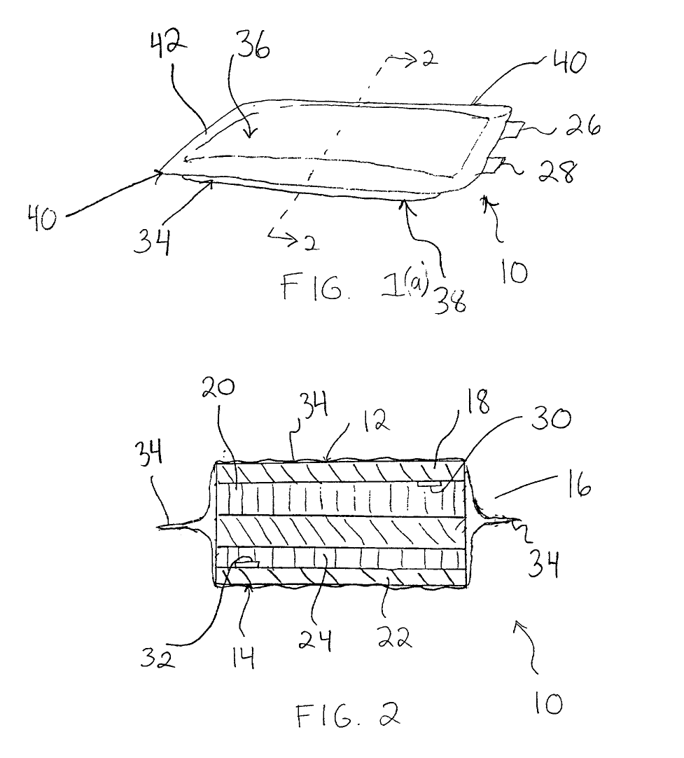

As shown in FIG. 2, an electrochemical battery, such as the illustrated lithium ion battery 10 typically includes a negative electrode side 12 (“anode”), a positive electrode side 14 (“cathode”) and a separator 16 therebetween. The negative electrode side 12 includes a current collector 18, which is typically constructed of nickel, iron, stainless steel or copper foil, and a negative electrode active material 20. Negative electrode active materials 20 may include, for example, lithium, lithium intercalated graphite, lithium alloys, such as, for example, alloys of lithium with aluminum, mercury, manganese, iron and zinc, to name a few.

The positive electrode side 14 includes a current collector 22, which is typically constructed of aluminum, nickel, iron, stainless steel, or copper, with a protective conducting coating foil over the surface of the current collector 22, and a positive electrode active material 24 that may be the same or different than the negative electrode active material 20. Positive electrode active materials 24 may include, for example, transition metal oxides, sulfides, selenides, and phosphates. Specifically, these materials may include oxides of cobalt, manganese, molybdenum and vanadium, sulfides of titanium, molybdenum and niobium, chromium oxides, copper oxides, and lithiated oxides of cobalt, manganese and nickel, lithiated phosphates of iron, cobalt, or molybdenum, to name a few.

The separator 16 is typically a solid electrolyte. A suitable electrolyte separator 16 may comprise, for example, a solid matrix containing an ionically conducting liquid with an alkali metal salt, with the liquid being an aprotic polar solvent, for example, ethylene carbonate and dimethyl carbonate. The component parts of the lithium ion battery 10 form a cell 11 and are assembled and packaged (i.e., sealed or encased) in an airtight packaging or casing 34 (e.g., flexible foil casing or housing) as shown in FIG. 2 to prevent exposure to external elements. It should be noted that depending upon the specific application requirements, including, for example, power rating and charging capacity, more than one cell 11 may be assembled within a single packaging or casing 34 to provide a lithium ion battery 10. When multiple cells 11 are packaged together, they may be packaged in, for example, a stacked configuration, bipolar arrays, or spirally wound long electrodes.

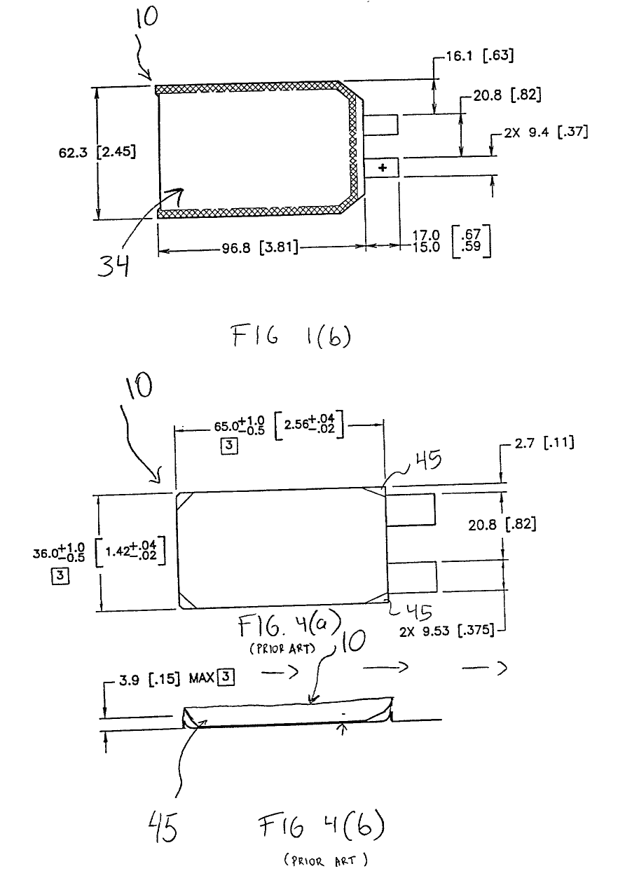

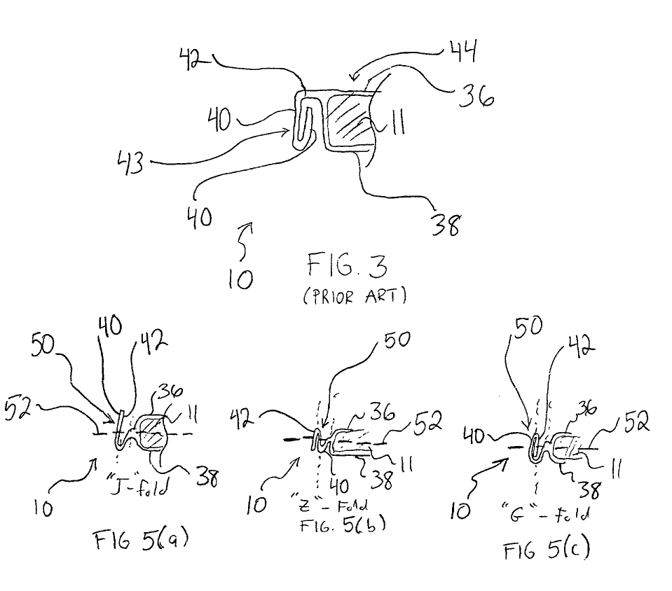

As shown in FIGS. 1(a) and 1(b), a sachet-packaged lithium ion battery 10 may be provided. The packaging or casing 34 typically includes a top surface 36 and a bottom surface 38 that are sealed at their edges 40 to provide an airtight environment for the cell 11 therein. The sealing arrangement forms an airtight perimeter portion 42 that extends from the top surface 36 and bottom surface 38. In particular, and as shown generally in FIGS. 3 and 4(a)-4(b), it has been known to fold the edges 40 together to seal the lithium ion battery 10 therein. The folding is accomplished by folding the top surface 36 and bottom surface 38 together from a top side 44 of the lithium ion battery 10 (i.e., folded onto itself). Chamfer corners 45 may also be provided to simplify folding (e.g., eliminate need to tuck material toward the cell and then fold). It should be noted that this type of fold (i.e., folded from the top) may be provided both as a compound fold 43 as shown in FIG. 3 and a single fold 45 as shown in FIGS. 4(a)-4(b). Different methods may be used to form the seal, including, for example, a sachet-type heat sealing arrangement. Further, and for example, a form package or a fin seal sachet (i.e., seal along center of top of package) may also be used.

In operation, and as shown in exemplary form in FIG. 2, the negative electrode side 12 of the lithium ion battery 10 is the anode during discharge, and the positive electrode side 14 is the cathode during discharge. Connection to the lithium ion battery 10 for powering external loads is provided using tabs or leads 26, 28 connected to the cell 11, using, for example, hot welding, such as spot welding, or cold welding, such as ultrasonic welding or friction welding. Further, a negative electrode side terminal 30 and a positive electrode side terminal 32 are provided as part of the lithium ion battery 10, and in combination with the tabs or leads 26, 28 provide power to the external loads (e.g., powering the electronics of a cellular phone).

Having described generally one type of battery (i.e., lithium ion battery 10) used for powering many smaller mobile devices and in connection with which the present invention may be implemented or constructed, the present invention provides a method of packaging a battery, such as, for example, a lithium ion battery 10, using a compound fold 50 (i.e., more than one fold with at least one fold in one direction, and at least another fold in the generally opposite direction) as shown in more detail in FIGS. 5(a)-(c). The compound fold 50 extends generally from a centerline 52 of the lithium ion battery 10, and preferably around the periphery of the lithium ion battery 10. It should be noted that depending upon the shape of the lithium ion battery 10, the centerline 52 is generally intermediate of the top portion 36 and the bottom portion 38. The compound fold 50 may be made in any suitable manner, including, for example, using a mechanical brake, or by sequentional off-set rollers, which curl the seal. Sealing engagement of the top surface 36 and bottom surface 38 to encase a cell 11 therein may be provided using, for example, heat sealing, impulse-heat sealing, or by ultrasonic sealing.

Specifically, the compound fold 50 may be configured in different shapes, including, for example, a “J” shape as shown in FIG. 5(a), a “Z” shape as shown in FIG. 5(b) or a “G” shape as shown in FIG. 5(c), among others. This compound fold 50 may provide a more compact design (e.g., narrowing the permissible design cell 11 width) for sealing and packaging a lithium ion battery 10, reduces complexity in packaging (e.g., reduces steps in packaging process, such as eliminating the need to form a package that would reduce material and cell 11 reliability, particularly during fabrication), and also provides a “spring” effect that dampens vibrations (i.e., compression of compound fold 50 reduces vibration). The compound fold 50 also may be used to clamp the lithium ion battery 10 within a cavity of an electronic device, thereby maintaining positioning of the lithium ion battery 10 within the electronic device. Essentially, the fold 50 may expand, due to this “spring” effect. If it does, it will expand outward in a direction longitudinal to the centerline of the cell 11. This applies a pressure against any barrier, which would be normal to the centerline of the cell 11. Barriers or stops within a device would be used (e.g., by the device designer) in order to locate the battery more effectively. The “spring” effect would help to position the battery into the desired location.

Thus, the present invention provides a method of packaging and sealing a battery (e.g., lithium ion battery 10) that can reduce the size of the battery, can provide flexibility in design (i.e., different shapes and operations for folding the seals), dampen mechanical vibrations (i.e., compound fold and clamping into device), and eliminate the need for forming of the package material, which can reduce package reliability during manufacture. Using a compound fold of the present invention to seal a battery within a packaging material (e.g., flexible foil packaging), different packaging processes may be used (e.g., wrap the package around the bottom edge of the cell 11, and seal the top edge or use two separate pieces of packaging foil, and fold each of the sides) and resistance to mechanical vibration and movement within an electronic device may be improved.

Although the present invention has been described in connection with packaging a lithium ion battery using different shape folds, it is not so limited, and the present invention may be provided to package and seal any type of laminar battery having one or more cells 11. Further, other shapes and configurations of folds may be made according to the principles of the present invention. For example, the compound fold may be provided in a different orientation relative to the cell 11 (e.g., horizontally versus vertically).

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of packaging a battery, the method comprising the steps of:
sealing a cell within a packaging material to form a substantially flat edge extending generally from a centerline of the cell; and
folding the edge seal along multiple substantially parallel lines from about the centerline of the cell.

2. The method according to claim 1 wherein the fold is configured in a J shape.

3. The method according to claim 1 wherein the fold is configured in a Z shape.

4. The method according to claim 1 wherein the fold is configured in a G shape.

5. The method according to claim 1 further comprising folding the packaging material along each of a side of the cell.

6. The method according to claim 1 wherein the packaging material comprises a flexible foil.

7. The method according to claim 1 wherein the cell thickness is less than about 6 millimeters.

8. A method of packaging a battery within a casing having a top and bottom surface, the method comprising the steps of:
sealing a cell within the top and bottom surfaces of the casing to form a substantially flat edge; and
compound folding the edge seal at a point intermediate to the top and bottom surfaces.

9. The method according to claim 8 wherein the step of compound folding comprises configuring the fold in a J shape.

10. The method according to claim 8 wherein the step of compound folding comprises configuring the fold in a Z shape.

11. The method according to claim 8 wherein the step of compound folding comprises configuring the fold in a G shape.

12. The method according to claim 8 wherein the top and bottom members each have a peripheral edge and the step of compound folding is performed along the peripheral edge of each side of the battery to seal the battery within the casing.

13. The method according to claim 8 wherein the casing comprises a flexible foil material.

14. The method according to claim 8 wherein the step of compound folding comprises configuring the fold in a coiled shape.

15. The method according to claim 8 wherein the battery is a lithium ion battery.

16. A battery comprising:
a cell having a positive electrode, a negative electrode, and a separator between the positive and negative electrodes;
a positive electrode terminal connected to the positive electrode;
a negative electrode terminal connected to the negative electrode, the terminals together adapted for providing power to an external load; and
a casing having a top and bottom surface for enclosing therein the cell, the top and bottom surfaces compound folded together with the fold extending generally from a point approximately intermediate to the top and bottom surfaces.

17. The battery according to claim 16 wherein the casing comprises a flexible foil material.

18. The battery according to claim 16 wherein the compound fold extends around a length and width of the cell.

19. The battery according to claim 16 wherein the compound fold is configured in a J shape.

20. The battery according to claim 16 wherein the compound fold is configured in a Z shape.

21. The battery according to claim 16 wherein the compound fold is configured in a G shape.

22. The battery according to claim 16 wherein the cell is a lithium ion cell.

23. An improved packaging for a battery having a top surface and a bottom surface sealed together along an edge, the improvement comprising:
a compound folded portion along the edge seal extending from a point intermediate to the top and bottom surfaces.

24. The improved packaging for a battery according to claim 23 wherein the compound folded portion is configured in a J shape.

25. The improved packaging for a battery according to claim 23 wherein the compound folded portion is configured in a Z shape.

26. The improved packaging for a battery according to claim 23 wherein the compound folded portion is configured in a G shape.

27. A method of packaging a battery, the method comprising the steps of:
sealing a cell within a packaging material to form a substantially flat edge extending from a centerline of the cell; and
forming a compound fold at the edge seal against the cell.

28. The method according to claim 27 wherein the fold is configured in a J shape.

29. The method according to claim 27 wherein the fold is configured in a Z shape.

30. The method according to claim 27 wherein the fold is configured in a G shape.
